(19) United States
(12) Patent Application Publication
(10) Pub. No.: US 2022/0236415 A1
(43) Pub. Date: Jul. 28, 2022

(54) LiDAR DEVICE AND METHOD OF MEASURING DISTANCE

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Jungwoo KIM, Hwaseong-si (KR); Jaehyuk CHOI, Seoul (KR); Hyeongseok SEO, Suwon-si (KR); Gihwan CHO, Incheon (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 17/499,100

(22) Filed: Oct. 12, 2021

(30) Foreign Application Priority Data
Jan. 22, 2021 (KR) 10-2021-0009756
Apr. 20, 2021 (KR) 10-2021-0051423

(51) Int. Cl. G01S 17/18; G01S 7/4865; G01S 7/484

(52) U.S. Cl. CPC G01S 17/18; G01S 7/4863; G01S 7/484; G01S 7/4865

(57) ABSTRACT

A light detection and ranging (LiDAR) device and a method of measuring a distance are provided. The LiDAR device includes: a light transmitter configured to transmit light to an object; a light receiver that includes a plurality of sub-light receiving regions that are included in one light receiving region corresponding to one pixel, each of the plurality of sub-light receiving regions including a light detection element configured to receive the light reflected from the object; and a processor configured to determine a time of flight (ToF) of the light that is transmitted to and then reflected from the object by varying a time window according to a measurement condition.

### CROSS-REFERENCE TO RELATED APPLICATIONS

This application is based on and claims priority under 35 U.S.C. § 119 to Korean Patent Applications Nos. 10-2021-0009756, filed on Jan. 22, 2021, and 10-2021-0051423, filed on Apr. 20, 2021, in the Korean Intellectual Property Office, the disclosures of which are incorporated by reference herein in their entireties.

### BACKGROUND

### 1. Field

The disclosure relates to a light detection and ranging (LiDAR) device and a method of measuring a distance.

### 2. Description of the Related Art

A light detection and ranging (LiDAR) system has been applied to various fields, such as space aeronautics, geology, three-dimensional maps, automobiles, robots, drones, etc.

As a basic operation principle, the LiDAR system uses the time of flight (hereinafter, referred to as the “ToF”) principle. That is, light may be transmitted from a light source toward an object, the light may be received by a sensor, and a ToF of light may be measured by using a high speed electrical circuit. A LiDAR device may calculate a distance to an object based on the ToF of light and may generate a depth image with respect to the object by using the distance calculated for each location of the object.

The ToF of light may be calculated through a statistical analysis of a histogram. That is, a laser ray having a predetermined pulse width is transmitted, and a statistical analysis of a histogram may be performed by using information obtained using a plurality of measurement cycles using a time window that is equal to or less than the pulse width to calculate the ToF of light.

However, in order to secure the accuracy, the number of histograms may have to be greatly increased. Also, because a reflection signal reflected from an object located in an external environment under abundant sunlight or an object located far is smaller than the emitted laser pulse width, the ToF of light may have a measurement error, when the same pulse width as a short distance is applied.

### SUMMARY

Provided are a light detection and ranging (LiDAR) device and a method of measuring a distance, which are capable of improving the accuracy of measuring the time of flight (ToF) of light by reducing a measurement error and capable of increasing an operation speed of a system by reducing the number of histograms.

Additional aspects will be set forth in part in the description which follows and, in part, will be apparent from the description, or may be learned by practice of the presented example embodiments of the disclosure.

According to an aspect of an embodiment, a light detection and ranging (LiDAR) device may include: a light transmitter configured to transmit light; a light receiver that includes at least one light receiving region, wherein the light receiving region including a plurality of sub-light receiving regions, each of the plurality of sub-light receiving regions including a light detection element configured to receive the light reflected from an object; and a processor configured to determine a time of flight (ToF) of the light that is transmitted to and then reflected from the object by varying a time window according to a measurement condition.

The measurement condition is at least one of a distance to the object and an illuminance of a use environment.

The processor may be further configured to vary the time window to apply a first time bin when the distance to the object is greater than a distance threshold or when the illuminance of the use environment is greater than an illuminance threshold, and to apply a second time bin, which is greater than the first time bin, when the distance to the object is less than or equal to the distance threshold or when the illuminance of the use environment is less than or equal to the illuminance threshold.

The processor may vary the time window according to the distance to the object, based on a degree of time delay of a stop signal generated when the light is received, with respect to a start signal generated when the light is transmitted.

The light detection element may include a single photon avalanche diode (SPAD).

The processor may include a pulse generator configured to generate a pulse signal having a pulse width with respect to a detection signal generated based on the light received by the light receiver, wherein the pulse generator may include: a comparator configured to generate the pulse signal by comparing an electrical signal generated by the light detection element of each of the plurality of sub-light receiving regions of the light receiver with a reference voltage; and a pulse shaper configured to vary the time window by varying the pulse width by selectively adjusting a delay of the pulse signal output from the comparator.

The pulse shaper may be further provided to vary the pulse width via a logical product of the pulse signal output from the comparator and a delayed pulse signal.

The pulse shaper may include: a delay portion configured to adjust the delay of the pulse signal according to a delay signal; and a gate device configured to obtain a logical product of the pulse signal and a delayed pulse signal, wherein the pulse width may be varied by adjusting the delay signal.

The delay signal may be adjusted to vary the time window by varying the pulse width to apply a first time bin when a distance to the object is greater than a distance threshold or an illuminance of a use environment is greater than an illuminance threshold, and to apply a second time bin that is greater than the first time bin when the distance to the object is less than or equal to the distance threshold or the illuminance of the use environment is less than or equal to the illuminance threshold.

The delay portion may include: a first inverter and a second inverter; a first transistor connected to be branched between the first inverter and the second inverter; a second transistor connected to be branched between the first transistor and the gate device; and a first capacitor and a second capacitor serially connected to the first transistor and the second transistor, respectively, wherein the delay signal may be input to the first transistor and the second transistor, and the delay portion may be provided to adjust the delay of the pulse signal by adjusting an output capacitance of the first inverter and the second inverter according to the delay signal.

The first transistor and the second transistor may include NMOS transistors.

The delay signal may be input as a ramp signal.

The delay signal may be in a range of 0.6 to 1.5 V.

The pulse width may be adjusted as 2 ns to 4 ns.

According to an aspect of another embodiment, a method of performing an object detection may include: radiating light to an object; receiving the light reflected from the object, via a light receiver that includes a plurality of sub-light receiving regions included in a light receiving region corresponding to one pixel, each of the plurality of sub-light receiving regions including a light detection element; and determining a time of flight (ToF) of the light that is radiated to and then reflected from the object by varying a time window according to a measurement condition.

The measurement condition may be at least one of a distance to the object and an illuminance of a use environment.

The time window may be varied to apply a first time bin, when the distance to the object is greater than a distance threshold or when the illuminance of the use environment is greater than an illuminance threshold, and to apply a second time bin, which is greater than the first time bin, when the distance to the object is less than or equal to the distance threshold or when the illuminance of the use environment is less than or equal to the illuminance threshold.

The varying of the time window may be performed by generating a pulse signal by comparing an electrical signal generated by the light detection element of each of the plurality of sub-light receiving regions of the light receiver with a reference voltage and varying a pulse width of the pulse signal by selectively adjusting a delay of the pulse signal.

### BRIEF DESCRIPTION OF THE DRAWINGS

The above and other aspects, features, and advantages of certain example embodiments of the disclosure will be more apparent from the following description taken in conjunction with the accompanying drawings, in which:

FIG. 1 exemplarily illustrates a method of varying a time window in a light detection and ranging (LiDAR) device, according to an embodiment;

FIG. 2 is a schematic block diagram illustrating a configuration of a LiDAR device according to an embodiment;

FIG. 3 illustrates a two-dimensional arrangement of a plurality of sub-light receiving regions forming a light receiving region of a light receiver of FIG. 2;

FIG. 4 schematically illustrates a main configuration of a processor of a LiDAR device according to an embodiment;

FIG. 5 illustrates a pulse generator of a processor of a LiDAR device according to an embodiment;

FIG. 6 schematically illustrates a main configuration of the pulse generator of FIG. 5 for processing a detection signal generated by a light detection element (a single photon avalanche diode (SPAD));

FIG. 7 illustrates a circuit configuration of a pulse shaper of the pulse generator of FIG. 5;

FIG. 8 illustrates an example of a weight value logic circuit portion of the pulse generator of FIG. 5, when each pixel of a light receiver includes 16 sub-pixels; and

FIG. 9 illustrates a signal change in each operation of a pulse generator in a LiDAR device according to an embodiment.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, example embodiments will be described in detail by referring to the accompanying drawings. In the drawings, the same reference numerals denote the same elements and sizes of elements may be exaggerated for clarity and convenience of explanation. Also, the embodiments described hereinafter are only examples, and various modifications may be made based on the embodiments.

Hereinafter, it will be understood that when an element is referred to as being “on” or “above” another element, the element can be directly over or under the other element and directly on the left or on the right of the other element, or intervening elements may also be present therebetween. Although the terms “first”, “second”, etc. may be used herein to describe various elements, these terms are only used to distinguish one element from another. These terms are not used to define differences of materials or structures between the elements. As used herein, the singular terms “a” and “an” are intended to include the plural forms as well, unless the context clearly indicates otherwise. It will be further understood that when a part “includes” or “comprises” an element, unless otherwise defined, the part may further include other elements, not excluding the other elements. The term “the” and other equivalent determiners may correspond to a singular referent or a plural referent.

Operations included in a method may be performed in an appropriate order, unless the operations included in the method are described to be performed in an apparent order, or unless the operations included in the method are described to be performed otherwise.

Also, the terms such as “. . . unit,” “module,” or the like indicate a unit, which processes at least one function or motion, and the unit may be implemented by hardware or software, or by a combination of hardware and software.

The connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of all examples and example terms are merely for describing the disclosure in detail and the disclosure is not limited to the examples and the example terms, unless they are not defined in the scope of the claims.

A light detection and ranging (LiDAR) device according to an embodiment obtains photon intensity information by superimposing the amount of photons incident to a time window in a histogram method, and calculates a distance using time information to an object.

Here, the time window may be varied according to an illuminance of a use environment or a time delay of a detection signal.

For example, a pulse width, at which a reflection signal reflected from an object in a use environment having a high illuminance, for example, an external environment having abundant sunlight, or an object located far is equal to or greater than a reference voltage, is less than a pulse width of light output from a light transmitter. Thus, when the same pulse width as a short distance is applied, a measurement error of the ToF may increase.

The LiDAR device according to an embodiment may calculate the ToF of light, by applying a time window of a first time bin, which is relatively small, when a time delay of a detection signal is large due to a great distance to an object or when an illuminance of a use environment is high, and applying a time window of a second time bin, which is relatively large, when the time delay of the detection signal is small due to a little distance to the object or when the illuminance of the use environment is low. Here, the first time bin and the second time bin may correspond to a pulse width, which is less than a pulse width of pulse light output from a light transmitter of the LiDAR device.

According to the LiDAR device according to an embodiment, the ToF of light is measured by using a histogram method having a pulse width (a time bin) varied according to a time delay of a detection signal and an illuminance by applying a time window spatially or temporally varied. Thus, the accuracy of the measurement of the ToF of light may be increased by reducing a measurement error. Also, because the time window is varied during one term of a measurement cycle, the number of measurement cycles for obtaining histogram information may be reduced, and an operation speed of the LiDAR device may be increased.

As described above, according to the LiDAR device according to an embodiment, a distance may be calculated by using time information with respect to an object, while varying a time window according to an illuminance of a use environment or a time delay of a detection signal. Thus, information about the ToF of light may be obtained with an increased accuracy. Here, a process of measuring the ToF of light while varying the time window may be performed in a temporal manner and a spatial manner.

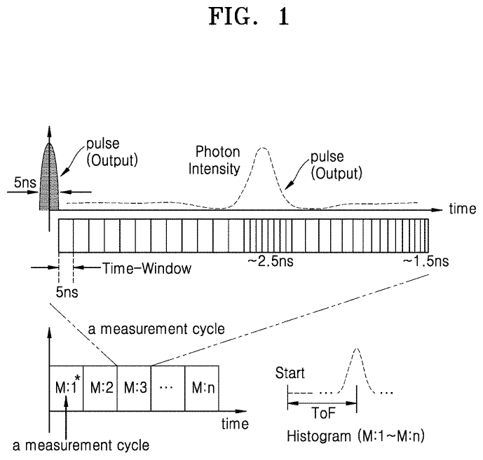

FIG. 1 exemplarily illustrates a method of varying a time window in a LiDAR device according to an embodiment.

Referring to FIG. 1, when pulse light having a predetermined pulse width, for example, a pulse width of 5 ns, is output from a light transmitter of the LiDAR device, and light reflected from an object OBJ and input in the form of pulse light is detected by a light receiver of the LiDAR device, a time window may be varied according to a time delay, during one term of a measurement cycle. Here, the time window may be equal to or less than the pulse width of the light transmission. FIG. 1 shows an example in which, when pulse light having a pulse width of 5 ns is used to measure a ToF, a time window is varied according to a time delay, within a range of about 1.5 ns to about 5 ns.

As described above, according to the LiDAR device according to an embodiment, a histogram may be obtained by detecting the light reflected from the object OBJ and signal processing for several measurement cycle M:1 through M:n while varying the time window according to the time delay. Also, the ToF of light may be calculated by using the histogram obtained as described above. In a histogram graph at the lower right end of FIG. 1, “Start” indicates a start point of a start signal of the light transmission. The ToF of light may be measured based on the start signal of the light transmission.

According to the LiDAR device according to an embodiment, by using the histogram obtained by performing the measurement cycle a plurality of times while varying the time window, the information of the ToF of light may be obtained with an increased accuracy. Here, a process of measuring the ToF of light while varying the time window may be performed in a temporal manner and a spatial manner.

For example, a pulse width, at which a reflection signal reflected from an object in a use environment having a high illuminance, for example, an external environment having abundant sunlight, or an object located far is equal to or greater than a reference voltage, is less than a pulse width of light output from the light transmitter. Thus, when the same pulse width as a short distance is applied, a measurement error of the ToF may be increased.

However, according to the LiDAR device according to an embodiment, the time window spatially or temporally varied may be applied, and thus, the measurement error may be reduced, thereby improving the accuracy of the ToF measurement may be improved. Also, the time window may be varied during one term of a measurement cycle, and thus, the number of terms of the measurement cycle for obtaining the histogram may be reduced, thereby improving the operation speed of the LiDAR device.

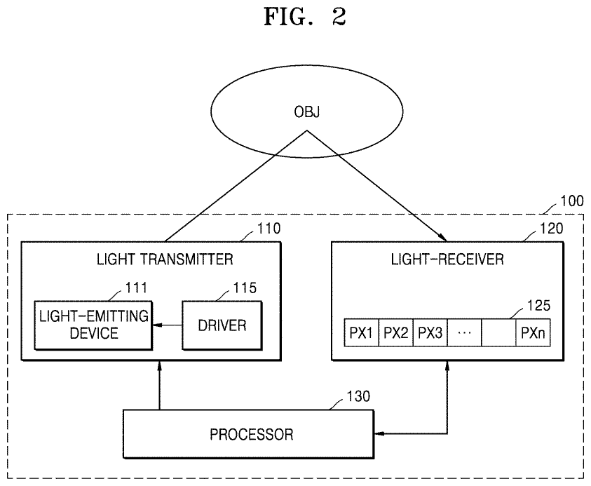

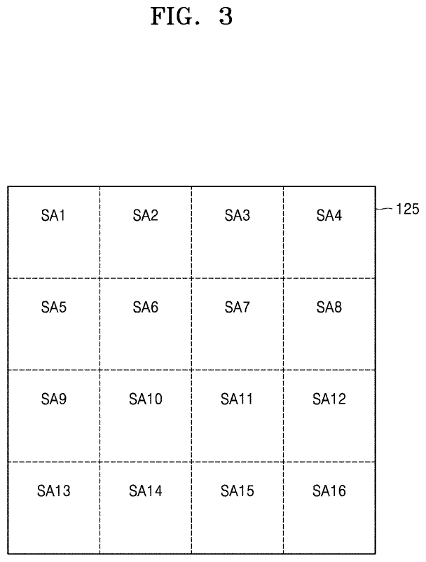

FIG. 2 is a schematic block diagram illustrating a configuration of a LiDAR device 100 according to an embodiment. FIG. 3 illustrates a two-dimensional arrangement of a plurality of sub-light receiving regions included in a light receiving region 125 of a light receiver of FIG. 2.

Referring to FIGS. 2 and 3, the LiDAR device 100 may include a light transmitter 110 configured to transmit light, a light receiver 120 configured to generate an electrical signal by receiving light reflected from an object, and a processor 130 configured to calculate a ToF of light by processing the electrical signal generated via the reception of the light by the light receiver 120. Components other than the components illustrated in FIG. 2 may further be included in the LiDAR device 100.

The light transmitter 110 may include at least one light-emitting device 111. Also, the light transmitter 110 may further include a driver 115 configured to drive the light-emitting device 111. The light-emitting device 111 of the light transmitter 110 may emit light to be used for an analysis of a location and a shape of an object. The light-emitting device 111 of the light transmitter 110 may emit light of a wavelength range appropriate for the analysis of the location and the shape of the object. For example, the light-emitting device 111 may emit light in an infrared range. When the light in an infrared range is used, mixing of the light with natural light in a visible range may be prevented. However, the disclosure is not necessarily limited thereto. The light-emitting device 111 of the light transmitter 110 may include light-emitting devices configured to radiate light of various wavelength ranges.

The light-emitting device 111 of the light transmitter 110 may include a laser diode (LD), an edge emitting laser, a vertical-cavity surface emitting laser (VCSEL), a distributed feedback laser, a light-emitting diode (LED), a super luminescent diode (SLD), etc.

The light transmitter 110 may radiate pulse light or continuous light from the light-emitting device 111 toward an object OBJ. Also, the light transmitter 110 may transmit the light toward the object OBJ a plurality of times.

As described above, the light transmitter 110 may include the light-emitting device 111 and the driver 115 and may radiate, toward the object OBJ, light emitted from the light-emitting device 111 according to the driving operation of the driver 115. For example, the light transmitter 110 may configure a radiation direction or a radiation angle of the light emitted from the light-emitting device 111. Also, the light transmitter 110 may configure the number of light transmissions from the light-emitting device 111.

The light transmitter 110 may include one light-emitting device or a plurality of light-emitting devices. Also, the light transmitter 110 may further include a predetermined component configured to change a traveling path of the light emitted from the light-emitting device 111. Also, the light transmitter 110 may be provided to scan a predetermined region of the object OBJ.

The light receiver 120 may receive reflection light of the light radiated toward the object OBJ. To this end, the light receiver 120 may include at least one light-receiving region 125, and the at least one light receiving region 125 may include a plurality of sub-light receiving regions each including a light detection element. For example, the light receiver 120 may include a plurality of light receiving region arrays 125 sectioned into a plurality of pixels PX1, PX2, PX3, . . . , and PXn. A plurality of light detection elements may be arranged in each of the plurality of pixels PX1, PX2, PX3, . . . , and PXn to respectively form a plurality of sub-pixels (the sub-light receiving regions).

The plurality of light receiving region arrays 125 may have a two-dimensional arrangement. That is, the plurality of light receiving region arrays 125 of the light receiver 120 may be formed as a structure in which the plurality of pixels PX1, PX2, PX3, . . . , and PXn are two-dimensionally arranged. Also, the plurality of sub-light receiving regions, that is, the plurality of sub-pixels, may be two-dimensionally arranged in each pixel, and the light detection element may be arranged in each sub-light receiving region (the sub-pixel). Accordingly, the light receiver 120 may include the plurality of light receiving regions (pixels) that are two-dimensionally arranged, and the plurality of light detection elements may be two-dimensionally arranged in each of the light receiving regions (pixels) to respectively form the plurality of sub-light receiving regions (sub-pixels).

For example, each light receiving region 125 of the light receiver 120 may include a plurality of sub-light receiving regions SA1 through SA16 as illustrated in FIG. 3. The light receiving region 125 may correspond to one pixel, and to section the light receiving region 125 into the plurality of sub-light receiving regions SA1 through SA16 is the same as to section one pixel into the plurality of sub-pixels. A light detection element may be arranged in each of the plurality of sub-light receiving regions SA1 through SA16. FIG. 3 illustrates that one light receiving region 125 includes 16 sub-light receiving regions SA1 through SA16, as an example. However, an embodiment is not limited thereto. The light receiver 120 may include at least one light receiving region 125, and the light receiving region 125 may include a plurality of sub-light receiving regions arranged n×m. Here, each of n and m is a natural number that is equal to or greater than 2. For example, each light receiving region may include 4, 9, 16, or 25 sub-light receiving regions that are two-dimensionally arranged.

The plurality of light detection elements of the light receiver 120 are sensors capable of detecting light, and for example, may be light receiving devices generating an electrical signal by light energy.

In the light receiver 120 according to an example embodiment, the light detection element arranged in each of the plurality of sub-light receiving regions of the at least one light receiving region 125 may be, for example, a single photon avalanche diode (SPAD) having a high sensing capability.

For example, the light detection element may be provided in each of the plurality of sub-light receiving regions included in the at least one light receiving region 125 of the light receiver 120, wherein the light detection elements of the sub-light receiving regions may be SPADs.

Light emitted from the light transmitter 110 and directed toward the object OBJ, and reflected by the object OBJ may be detected in at least one or more sub-light receiving regions of the light receiving region 125 of the light receiver 120. The light reflected by the object OBJ may be detected over the entire plurality of sub-light receiving regions of the light receiving region 125.

The light receiver 120 may further include an optical element for focusing the reflection light of the light radiated toward the object OBJ to a predetermined pixel.

When the light receiver 120 receives the reflection light, the light receiver 120 may convert the reflection light into a stop signal. The stop signal may be used to calculate the ToF of light together with a start signal generated when the light transmitter 110 transmits the light.

The light receiver 120 may include a circuit including a current-voltage signal converter, a band pass filter, etc., in a one-to-one correspondence with the light detection element provided in each of the plurality of sub-light receiving regions of the at least one light receiving region 125. The current-voltage signal converter may convert a current signal generated by receiving light from the light detection element into a voltage signal. The band pass filter may be provided to pass a detection signal with respect to the light emitted from the light transmitter 110 and to remove offset noise due to external light. The band pass filter may include, for example, a high frequency band pass filter (HPF). The circuit of the light receiver 120 may further include an amplifier, etc. to correspond one-to-one with the light detection element. The amplifier may be integrally provided with the band pass filter or separately provided from the band pass filter.

When the light receiver 120 includes the circuit, such as the current-voltage signal converter, etc., the electrical signal generated by detecting light in the light receiver 120, that is, a detection signal, may be output from the light receiver 120 as a voltage signal. Here, the detection signal output from the light receiver 120 may be an analog signal.

When the light detection element includes an SPAD, while sensing sensitivity may be high, but noise may also be increased. Thus, in order to reliably calculate the ToF of light by using the SPAD, a process may be used, in which light may be radiated toward the object OBJ a plurality of times, a histogram of detection signals of light reflected from the object OJ may be generated by applying a time window, and the histogram may be statistically analyzed.

To this end, according to the LiDAR device 100 according to an embodiment, the processor 130 may be provided to process the detection signal generated via light detection by the light detection element of each of the plurality of sub-light receiving regions and to calculate the ToF of light by varying the time window according to a measurement condition. Here, the measurement condition may be at least one of a distance toward the object OBJ and an illuminance of a use environment. The distance to the object OBJ may be expressed as a time delay of the detection signal of the light reflected from the object OBJ and received by the light receiver 120.

For example, the processor 130 may vary the time window to apply a first time bin when the distance to the object OBJ is far or the illuminance of the use environment is high, and a second time bin that is greater than the first time bin when the distance to the object is close or the illuminance of the use environment is low. Here, the varying of the time window according to the distance to the object may be performed according to a degree of a time delay of a stop signal generated when the light is received, with respect to a start signal generated when the light is transmitted.

Thus, the processor 130 may vary the time window according to the illuminance of the use environment or the time delay of the detection signal. The processor 130 may apply the time window of the first time bin that is relatively small to calculate the ToF of light, when the distance to the object OBJ is far (when the distance to the object OBJ is greater than a distance threshold) so that the time delay of the detection signal is large (e.g., when the time delay is greater than a delay threshold), or when the illuminance of the use environment is high (e.g., when the illuminance of the use environment is greater than an illuminance threshold). The processor 130 may apply the time window of the second time bin that is relatively greater to calculate the ToF of light, when the distance to the object OBJ is close (e.g., when the distance to the object OBJ is less than or equal to the distance threshold) so that the time delay of the detection signal is small large (e.g., when the time delay is less than or equal to the delay threshold), or when the illuminance of the use environment is low (e.g., when the illuminance of the use environment is less than or equal to illuminance threshold). Here, the first time bin and the second time bin may correspond to a width that is less than a pulse width of pulse light output from the light transmitter 110.

For example, when the light transmitter 110 outputs pulse light having, for example, a pulse width of about 5 ns, and the light receiver 120 detects light that is reflected from the object OBJ and input in the form of pulse light, the time window may be varied according to the time delay during one term of a measurement cycle. Here, the time window may be equal to or less than the pulse width of the light transmission. For example, when the pulse light having the pulse width of about 5 ns is used to measure the ToF, the time window may be varied according to the time delay within a range of about 1.5 ns to about 5 ns.

As described above, according to the LiDAR device 100 according to an embodiment, the histogram may be obtained by detecting the light reflected from the object OBJ and processing the detection signal in the processor 130 during a plurality of terms of the measurement cycle while varying the time window according to the time delay. Also, the processor 130 may calculate the ToF of light by using the histogram obtained as described above. Here, the ToF of light may be measured based on the start signal when the light is transmitted.

According to the LiDAR device 100 according to an embodiment, by using the histogram obtained by performing the measurement a plurality of times while varying the time window, information about the ToF of light may be obtained with an improved accuracy. Here, the process of measuring the ToF of light while varying the time window may be performed in a temporal manner and a spatial manner.

For example, a pulse width, at which a reflection signal reflected from an object in a use environment having a high illuminance, for example, an external environment having abundant sunlight, or an object located far is equal to or greater than a reference voltage, is less than a pulse width of light output from the light transmitter 110. Thus, when the same pulse width as a short distance is applied, a measurement error of the ToF may be increased.

However, according to the LiDAR device according to an embodiment, the time window spatially or temporally varied may be applied, and thus, the measurement error may be reduced, to improve the accuracy of the ToF measurement. Also, the time window may be varied during one term of a measurement cycle, and thus, the number of terms of the measurement cycle for obtaining the histogram may be reduced, so that the operation speed of the LiDAR device may improve.

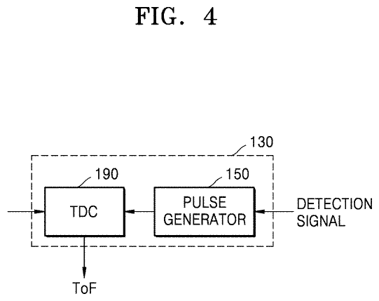

FIG. 4 schematically illustrates a main configuration of the processor 130 of the LiDAR device 100 according to an embodiment.

Referring to FIG. 4, the processor 130 may include a pulse generator 150 and a time-to-digital converter (TDC) 190. In addition, the processor 130 may further include an additional component for measuring the ToF of light by using the histogram method while applying spatially or temporally variable time window.

The pulse generator 150 may generate a pulse signal having a width with respect to a detection signal generated by receiving light from the light receiver 120. The pulse generator 150 may be provided to generate the pulse signal by applying, for example, a spatially variable time window.

The TDC 190 may generate a histogram by using the pulse signal generated by the pulse generator 150 and may calculate in how many cycles a clock signal is generated with respect to a start signal generated at the point of light radiation of the light transmitter 110 to measure the ToF of light. The start signal may be used to calculate the ToF of light.

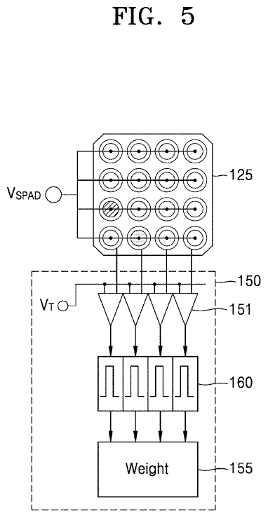

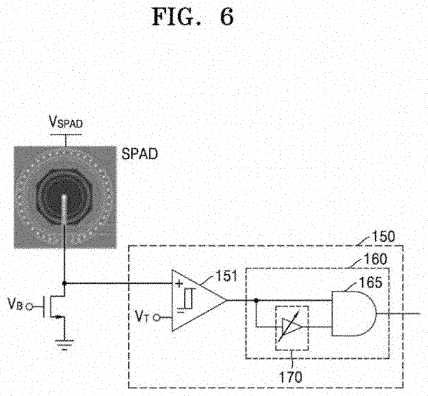

FIG. 5 illustrates the pulse generator 150 of the processor 130. FIG. 5 illustrates a method in which one pixel includes a plurality of sub-pixels, and whether there is a signal or not is determined according to the number of sub-pixels firing via an incident photon, by applying coincidence detection manner in a manner that spatially varies time window. FIG. 6 schematically illustrates a main configuration of the pulse generator 150 of FIG. 5, configured to process a detection signal generated by the light detection element (an SPAD).

Referring to FIG. 5, the pulse generator 150 may generate a pulse having a predetermined width at an occurrence time, regardless of a quenching speed of the light detection element, for example, the SPAD, of the light receiver 120, and may use the pulse having the predetermine width by overlapping (coincidence detecting) a pulse signal generated from a neighboring pixel.

The pulse width generated by the pulse generator 150 may be varied according to the amount of light in real time and a time delay of the detection signal, during a measurement period, and the pulse width may be decreased as the amount of light is increased or the time delay of the detection signal is increased.

To make this operation possible, the pulse generator 150 may include a comparator 151 configured to generate a pulse signal by comparing the detection signal generated by the light detection element of the light receiver 120 with a reference voltage, and a pulse shaper (e.g., a pulse shaping filter) 160 configured to vary a time window by varying a pulse width. Also, the pulse generator 150 may further include a weight value logic circuit portion 155 configured to determine whether or not an event occurs.

The comparator 151 may generate the pulse signal by comparing the detection signal generated by the light detection element, for example, the SPAD, of each of the plurality of sub-light receiving regions of the at least one light receiving region 125 of the light receiver 120, with a reference voltage. The comparator 151 may be provided to correspond one-to-one with the light detection element of each of the plurality of sub-light receiving regions. FIG. 5 illustrates an example in which 16 light detection elements are arranged in one pixel to form a 4×4 arrangement, such that 16 sub-light receiving regions are included in one light receiving region 125 of the light receiver 120. Also, although FIG. 5 illustrates only four comparators 151 for convenience, the comparator 151 may be provided to correspond one-to-one with the light detection element of each of the plurality of sub-light receiving regions. For example, 16 comparators 151 may be provided to correspond to 16 light detection elements.

As illustrated in FIG. 6, the comparator 151 may be provided to correspond one-to-one with each light detection element, for example, the SPAD, of the sub-pixel.

The pulse shaper 160 may be provided to vary the time window by varying the pulse width by selectively adjusting a delay of the pulse signal output from the comparator 151. As illustrated in FIG. 6, the pulse shaper 160 may be provided to correspond one-to-one with the comparator 151.

For example, the pulse shaper 160 may be provided to generate a delayed pulse signal and vary the time window by varying a pulse width by using a logic product (AND operation) of a pulse signal and the delayed pulse signal.

To this end, as illustrated in FIG. 6, the pulse shaper 160 may include a delay portion 170 configured to generate the delayed pulse signal by adjusting a delay of the pulse signal according to a delay signal V_{delay} and a gate device 165 configured to obtain the logic product of the pulse signal and the delayed pulse signal. A width of a pulse output from the gate device 165 may be varied by adjusting the delay signal V_{delay} input to the delay portion 170.

When an output of the comparator 151 becomes 1 according to the reaction of one light detection element, an output of the pulse shaper 160 may also become 1, and thereafter, and then, after a predetermined delay by the delay portion 170 passes and before the output of the comparator 151 becomes 0, the output of the pulse shaper 160 may fall to 0.

Here, a time at which the output of the pulse shaper 160 falls to 0 may be changed according to the delay signal V_{delay} input to the delay portion 170, and thus, the pulse width may be varied according to the input delay signal V_{delay}.

The delay signal V_{delay} may be adjusted to vary the time window according to a measurement condition. Here, the measurement condition may be at least one of a distance to an object and an illuminance of a use environment.

For example, the delay signal V_{delay} may be adjusted, to vary the time window by varying the pulse width to apply a first time bin when the distance to the object is large or the illuminance of the use environment is high and to apply a second time bin that is greater than the first time bin when the distance to the object is close or the illuminance of the use environment is low.

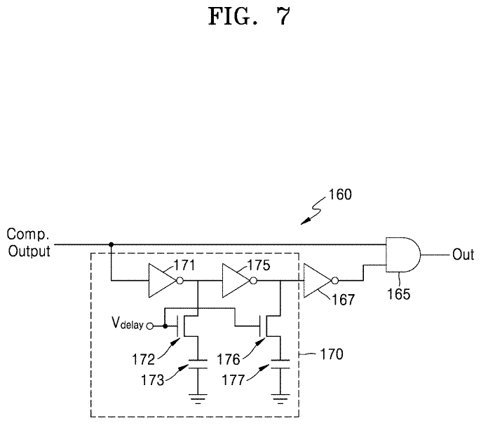

FIG. 7 illustrates a circuit configuration of the pulse shaper 160.

Referring to FIG. 7, the delay portion 170 of the pulse shaper 160 may include, for example, two inverters (first and second inverters 171 and 175), two transistors (first and second transistors 172 and 176), and two capacitors (first and second capacitors 173 and 177). Here, the first and second transistors 172 and 176 may include, for example, NMOS transistors.

For example, the delay portion 170 of the pulse shaper 160 may include the first and second inverters 171 and 175, the first transistor 172 connected to be branched between the first and second inverters 171 and 175, the second transistor 176 connected to be branched between the first transistor 172 and the gate device 165 and the first and second capacitors 173 and 177 serially connected to the first and second transistors 172 and 176, respectively. The first and second transistors 172 and 176 may include, for example, NMOS transistors.

A delay signal V_{delay} may be input into each of the first and second transistors 172 and 176. The delay portion 170 may adjust a delay of a pulse signal by adjusting an output capacitance of the first and second inverters 171 and 175 according to the delay signal V_{delay}.

When an output of the comparator 151, that is, a pulse signal, is input into the pulse shaper 160, the pulse signal may be divided to pass through the delay portion 170, and thus, a pulse signal corresponding to the output of the comparator 151 and a pulse signal delayed by passing through the delay portion 170 may be input into the gate device 165. The gate device 165 may output a pulse signal corresponding to a logic product of the pulse signal and the delayed pulse signal.

The pulse shaper 160 according to an embodiment may further include a third inverter 167 between the delay portion 170 and the gate device 165, as illustrated in FIG. 7, and, according to necessity, may further include an additional circuit component.

As illustrated in FIG. 7, the delay portion 170 may be configured to include the two inverters 171 and 175, the two NMOS transistors 172 and 176, and the capacitors 173 and 177, and may adjust a pull-up or pull-down delay by adjusting the output capacitance of the inverters 171 and 175, according to a magnitude of the delay signal V_{delay}. The delay signal V_{delay} may be a ramp signal input from an off-chip and may constantly decrease from when light is radiated from the light transmitter 110 of the LiDAR device 100 until a maximum measurement distance is reached. Due to this delay signal V_{delay}, for example, the pulse width output from the pulse shaper 160 may gradually decrease. In the LiDAR device 100 using the structure of the delay portion 170 of FIG. 7, a range of the delay signal V_{delay} may be, for example, between about 0.6 and about 1.5 V, and thus, the pulse width may be adjusted to 2 ns to 4 ns.

Referring to FIG. 5 again, the pulse generator 150 may further include the weight value logic circuit portion 155 configured to determine whether or not an event occurs. When the light receiver 120 has a structure in which each pixel includes a plurality of sub-pixels, and as a light detection element included in each sub-pixel, an SPAD is applied, the light receiver 120 may determine whether the number of light detection elements generating an event in each pixel is equal to or greater than a threshold value, and thus determining that there is a signal when the number of light detection elements generating an event in each pixel is equal to or greater than the threshold value.

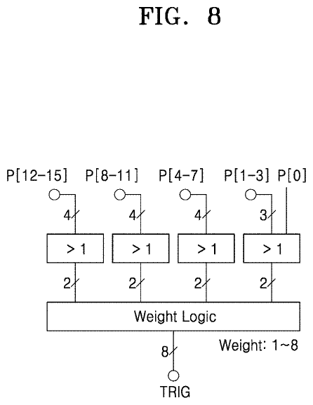

FIG. 8 illustrates an example of the weight value logic circuit portion 155 of the pulse generator 150 of FIG. 5, when each pixel of the light receiver 120 includes 16 sub-pixels.

Referring to FIG. 8, the weight value logic circuit portion 155 may set a threshold value of the number of light detection elements in which an event occurs. When the number of light detection elements occurring an event in each pixel is, for example, in a range of 1 to 8, the weight value logic circuit portion 155 may determine that there is a signal and may generate a trigger TRIG.

For example, the plurality of sub-pixels may be classified into four sub-pixel groups P[0-3], P[4-7], P[8-11], and P[12-15], and the number of sub-pixels reacting by photons may be counted in each sub-pixel group. FIG. 8 illustrates an example in which, when the number of light detection elements occurring an event in each sub-pixel group is two, and when an event is occurred from the total 8 light detection elements, that is, when the weight value is 8, it is determined that there is a signal. The threshold value about the number of light detection elements occurring an event may be determined, for example, within a range of 1 to 8.

As described above, the pulse generator 150 may include the comparator 151 configured to generate the pulse signal by comparing the detection signal generated by each light detection element with the reference voltage and the pulse shaper 160 configured to vary the time window by selectively adjusting the delay of the pulse signal to vary the pulse width. Also, the pulse generator 150 may further include the weight value logic circuit portion 155 configured to determine that there is a signal when the number of light detection elements from which an event is occurred is equal to or greater than a threshold value.

The pulse width of the pulse signal generated by the pulse generator 150 may be adjusted to vary the time window according to a measurement condition, through adjusting the delay signal V_{delay} input into the delay portion 170 of the pulse shaper 160. Here, the measurement condition may be at least one of an illuminance of a use environment and a time delay (a distance to an object) of a detection signal of the light receiver.

For example, the delay signal V_{delay} may be adjusted to vary the time window by varying the pulse width to apply a first time bin when the distance to the object is far or the illuminance of the use environment is high and to apply a second time bin that is greater than the first time bin when the distance to the object is close or the illuminance of the use environment is low.

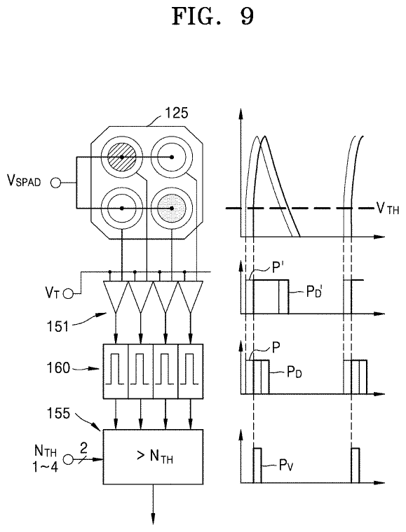

FIG. 9 illustrates a signal change in each operation of the pulse generator 150 in the LiDAR device 100 according to an embodiment.

The comparator 151 may generate a pulse signal by comparing a detection signal generated by the light detection element with a reference voltage V_{TH}. In the operation of the comparator 151, P′ indicates the pulse signal generated by the comparator 151 and corresponds to a signal detected by the light detection element. P_{D}′ indicates a pulse signal delayed from the pulse signal P′ to correspond to a delay of the pulse shaper 160 and may correspond to a delay of the signal detected by the light detection element.

The pulse shaper 160 may, with respect to a pulse signal output from the comparator 151, generate the delayed pulse signal by varying a degree of delay according to a measurement condition, for example, a time delay of the detection signal and an illuminance of an external environment, and may generate a pulse signal having a pulse width (a time bin) varied according to the measurement condition, via a logic product of the pulse signal output from the comparator 151 and the delayed pulse signal P_{D}′. In the operation of the pulse shaper 160, P indicates a pulse signal generated in the operation of the pulse shaper 160, which is not delayed, with respect to the pulse signal P′, P_{D} indicates a delayed signal having a varied degree of delay according to the measurement condition, such as the time delay and the illuminance, with respect to the pulse signal P, and P_{V} indicates a pulse signal having a varying pulse width, which is obtained via a logic product of the pulse signal P and the delayed pulse signal P_{D}.

When the number of light detection elements outputting the pulse signal P_{V} in the pulse shaper 160 is equal to or greater than a threshold value N_{TH}, the LiDAR device 100 may determine that there is a signal detecting the object OBJ. FIG. 9 illustrates an example in which each pixel includes four sub-pixels. In this case, the threshold value N_{TH} of the number of light detection elements occurring an event may be in the range of 1 to 4.

When it is determined that there is the signal detecting the object OBJ, the TDC 190 of the processor 130 may generate a histogram by using the pulse signal generated by the pulse generator 150 and may measure the ToF of light by calculating the number of cycles in which a clock signal is generated from the point of light radiation by the light transmitter 110.

According to the LiDAR device 100 according to above-described embodiment, the time window method that is temporally or spatially varied is used, and thus, a measurement error due to a use environment or a distance to an object, such as an external environment having abundant sunlight or an object located far, may be reduced, and thus, the measurement accuracy of the ToF may be increased. Also, by applying the light receiver 120 including a plurality of sub-pixels in each pixel, it may be determine that there is a signal, when the number of light detection elements occurring an event is equal to or greater than a threshold value. Thus, the number of histograms may be reduced, and an operation speed of the LiDAR device 100 may be improved.

According to the LiDAR device and the method of measuring the distance according to above-described embodiment, by applying a variable time window to reduce the measurement error, the measurement accuracy of the ToF may be improved, and a signal to noise ratio may be improved. Thus, the signal detection characteristics may be improved, and the detection distance may be increased.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A light detection and ranging (LiDAR) device comprising:
a light transmitter configured to transmit light to an object;
a light receiver that comprises at least one light receiving region, wherein the light receiving region comprising a plurality of sub-light receiving regions, each of the plurality of sub-light receiving regions comprising a light detection element configured to receive the light reflected from the object; and
a processor configured to determine a time of flight (ToF) of the light that is transmitted to and then reflected from the object by varying a time window according to a measurement condition.

2. The LiDAR device of claim 1,
wherein the measurement condition is at least one of a distance to the object and an illuminance of a use environment.

3. The LiDAR device of claim 2,
wherein the processor is further configured to vary the time window to apply a first time bin when the distance to the object is greater than a distance threshold or when the illuminance of the use environment is greater than an illuminance threshold, and to apply a second time bin, which is greater than the first time bin, when the distance to the object is less than or equal to the distance threshold or when the illuminance of the use environment is less than or equal to the illuminance threshold.

4. The LiDAR device of claim 2,
wherein the processor varies the time window according to the distance to the object, based on a degree of time delay of a stop signal generated when the light is received, with respect to a start signal generated when the light is transmitted.

5. The LiDAR device of claim 1,
wherein the light detection element includes a single photon avalanche diode (SPAD).

6. The LiDAR device of claim 1,
wherein the processor comprises a pulse generator configured to generate a pulse signal having a pulse width with respect to a detection signal generated based on the light received by the light receiver,
wherein the pulse generator comprises:
a comparator configured to generate the pulse signal by comparing an electrical signal generated by the light detection element of each of the plurality of sub-light receiving regions of the light receiver with a reference voltage; and
a pulse shaper configured to vary the time window by varying the pulse width by selectively adjusting a delay of the pulse signal output from the comparator.

7. The LiDAR device of claim 6,
wherein the pulse shaper is further provided to vary the pulse width via a logical product of the pulse signal output from the comparator and a delayed pulse signal.

8. The LiDAR device of claim 6,
wherein the pulse shaper comprises:
a delay portion configured to adjust the delay of the pulse signal according to a delay signal; and
a gate device configured to obtain a logical product of the pulse signal and a delayed pulse signal,
wherein the pulse width is varied by adjusting the delay signal.

9. The LiDAR device of claim 8,
wherein the delay signal is adjusted to vary the time window by varying the pulse width to apply a first time bin when a distance to the object is greater than a distance threshold or an illuminance of a use environment is greater than an illuminance threshold, and to apply a second time bin that is greater than the first time bin when the distance to the object is less than or equal to the distance threshold or the illuminance of the use environment is less than or equal to the illuminance threshold.

10. The LiDAR device of claim 8,
wherein the delay portion comprises:
a first inverter and a second inverter;
a first transistor connected to be branched between the first inverter and the second inverter;
a second transistor connected to be branched between the first transistor and the gate device; and
a first capacitor and a second capacitor serially connected to the first transistor and the second transistor, respectively,
wherein the delay signal is input to the first transistor and the second transistor, and
the delay portion is provided to adjust the delay of the pulse signal by adjusting an output capacitance of the first inverter and the second inverter according to the delay signal.

11. The LiDAR device of claim 10,
wherein the first transistor and the second transistor include NMOS transistors.

12. The LiDAR device of claim 8,
wherein the delay signal is input as a ramp signal.

13. The LiDAR device of claim 8,
wherein the delay signal is in a range of 0.6 to 1.5 V.

14. The LiDAR device of claim 8,
wherein the pulse width is adjusted as 2 ns to 4 ns.

15. A method of performing an object detection, the method comprising:
radiating light to an object;
receiving the light reflected from the object, via a light receiver that comprises a plurality of sub-light receiving regions included in a light receiving region corresponding to one pixel, each of the plurality of sub-light receiving regions comprising a light detection element; and
determining a time of flight (ToF) of the light that is radiated to and then reflected from the object by varying a time window according to a measurement condition.

16. The method of claim 15,
wherein the measurement condition is at least one of a distance to the object and an illuminance of a use environment.

17. The method of claim 16,
wherein the time window is varied to apply a first time bin, when the distance to the object is greater than a distance threshold or when the illuminance of the use environment is greater than an illuminance threshold, and to apply a second time bin, which is greater than the first time bin, when the distance to the object is less than or equal to the distance threshold or when the illuminance of the use environment is less than or equal to the illuminance threshold.

18. The method of claim 15,
wherein the varying of the time window is performed by generating a pulse signal by comparing an electrical signal generated by the light detection element of each of the plurality of sub-light receiving regions of the light receiver with a reference voltage and varying a pulse width of the pulse signal by selectively adjusting a delay of the pulse signal.
